(19) United States
(12) Patent Application Publication
(10) Pub. No.: US 2011/0238582 A1
(43) Pub. Date: Sep. 29, 2011

(54) Service Method For Customer Self-Service And Rapid On-Boarding For Remote Information Technology Infrastructure Monitoring And Management

(75) Inventors: Anthony J. Dasari, Austin, TX (US); Michael R. Head, Tarrytown, NY (US); Anca Sailer, Scarsdale, NY (US); Hidayatullah Habeebullah Shaikh, Mohengan Lake, NY (US); Manu Sharma, Karnataka (IN); Mahesh Viswanathan, Yorktown Heights, NY (US)

(73) Assignee: International Business Machines Corporation, Armonk, NY (US)

(21) Appl. No.: 12/729,672

(22) Filed: Mar. 23, 2010

(51) Int. Cl. G06Q 50/00; G06Q 30/00; G06Q 10/00; G06F 15/173; G06F 21/20

(52) U.S. Cl. 705/80; 705/400; 709/224; 726/15; 705/26.5

(57) ABSTRACT

In accordance with one aspect of the embodiments of this invention there is a method to initiate remote managed infrastructure services for a customer infrastructure site. The method includes, in response to an inquiry from a potential customer, provisioning the potential customer with a remote managed infrastructure services software client; using the provisioned software client, performing an automated process to detect specifics of a customer information technology infrastructure; in response to the customer confirming the detected specifics of customer information technology infrastructure, configuring a remote managed infrastructure service to monitor and manage all or a subset of the detected and confirmed customer information technology infrastructure.

### TECHNICAL FIELD

The embodiments of this invention relate generally to data processing systems and networks and, more specifically, relate to the remote management and monitoring of information technology infrastructure.

### BACKGROUND

The following abbreviations that appear in the description and/or the drawing figures are defined as follows:

CMDB configuration management database
DB database
FW firewall
ICMP interne control message protocol
IT information technology
KPI key performance indicator(s)
NAT network address translation
NMAP network mapper
OS operating system
PC personal computer
RMIS remote managed infrastructure services
SMB small and medium-sized business
VPN virtual private network

The RMIS market is rapidly emerging and growing. One significant advantage in the use of RMIS is that it aids global enterprises and SMBs to reduce their IT infrastructure management costs.

One process to achieve customer on-boarding (i.e., generally the preparation, installation, set-up and configuration of a customer's IT environment) of an RMIS offering includes multiple direct or phone interactions with the customer to identify the customer's IT environment and the resources to be managed, and to guide the customer to enable their IT environment for remote management. Customer environments are often very different and require careful documentation of the layout and details of the IT elements before a prescription and execution of a remote IT management plan can be prepared. Further. as IT environments grow ever larger and more complex this approach is becoming more cumbersome and less effective. Among the common problems that can occur are inaccuracies in manually assessing the IT environment from the customer's descriptions or from semi-updated files; missing configuration data (e.g., credentials, directory paths, KPIs) necessary to setup the monitoring systems; overhead for the SMB customer expected to perform complex configurations in their environment (e.g., VPN setup, monitoring data collector installation); the inherent latency of the on-boarding process due to the need to perform manual operations, as well as a potential lack of a systematic approach for achieving operations flow.

As can be appreciated, a need exists to improve the installation, set-up and configuration (i.e., the on-boarding) of RMIS at end-user locations.

### SUMMARY

The foregoing and other problems are overcome, and other advantages are realized, in accordance with the exemplary embodiments of this invention.

In one aspect of the embodiments of this invention there is a method to initiate remote managed infrastructure services for a customer infrastructure site. The method includes, in response to an inquiry from a potential customer, provisioning the potential customer with a remote managed infrastructure services software client; using the provisioned software client, performing an automated process to detect specifics of a customer information technology infrastructure; in response to the customer confirming the detected specifics of customer information technology infrastructure, configuring a remote managed infrastructure service to monitor and manage all or a subset of the detected and confirmed customer information technology infrastructure.

In another aspect of the embodiments of this invention there is a computer-readable storage medium having computer-executable program code stored thereon or therein. Execution of the program code results in initiating remote managed infrastructure services for a customer infrastructure site comprising operations of, in response to an inquiry from a potential customer, provisioning the potential customer with a remote managed infrastructure services software client; using the provisioned software client, performing an automated process to detect specifics of the customer's information technology infrastructure; in response to the customer confirming the detected specifics of customer information technology infrastructure, checking the prerequisites to configure the remote managed infrastructure service, and configuring a remote managed infrastructure service to monitor and manage all or a subset of the detected and confirmed customer information technology infrastructure.

In yet another aspect of the embodiments of this invention there is a system that comprises at least one computer coupled with at least one memory containing computer-executable program code stored thereon or therein. The at least one computer is further coupled with a data communications network. Execution of the program code results in the system providing remote managed infrastructure services for a customer infrastructure site comprising, in response to an inquiry from a potential customer, provisioning the potential customer with a remote managed infrastructure services software client; using the provisioned software client, performing an automated process to detect specifics of a customer information technology infrastructure; in response to the customer confirming the detected specifics of customer information technology infrastructure, configuring a remote managed infrastructure service to monitor and manage all or a subset of the detected and confirmed customer information technology infrastructure.

### BRIEF DESCRIPTION OF THE SEVERAL VIEWS OF THE DRAWINGS

FIGS. 1A and 1B, collectively referred to as FIG. 1, depict a logic flow diagram of a process in accordance with the exemplary embodiments of this invention.

FIG. 2 is a diagram of a non-limiting example of a remote managed services infrastructure site and a customer on-boarding process.

FIG. 3 is a block diagram of a data processing system that is an exemplary embodiment of any one of the various components shown in FIG. 2.

### DETAILED DESCRIPTION

The exemplary embodiments of this invention improve on the current manual customer on-boarding of RMIS by providing a highly automated remote managed services on-boarding process.

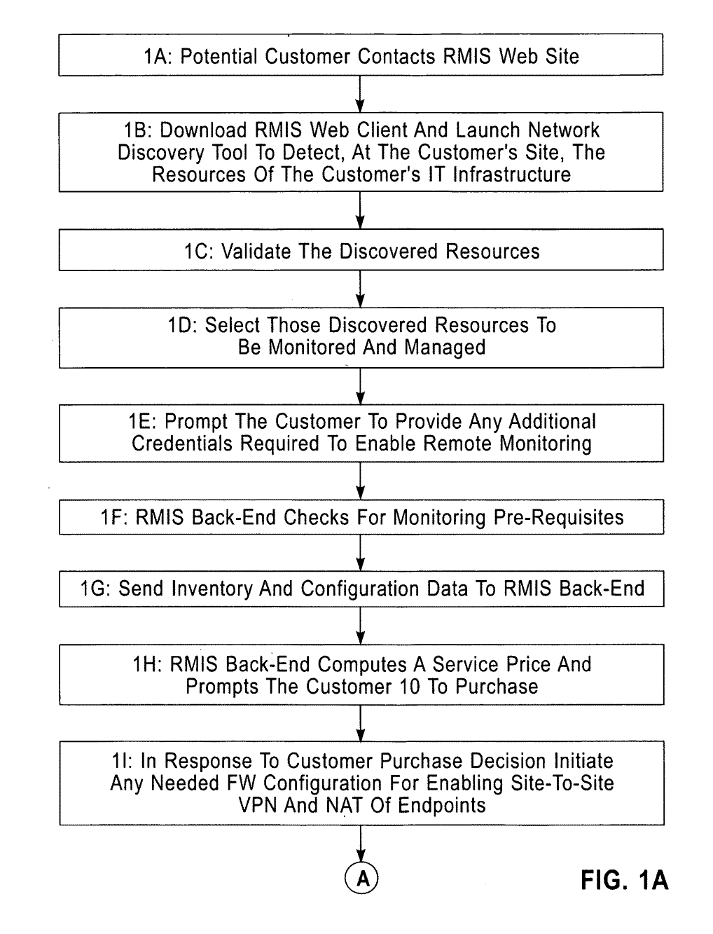

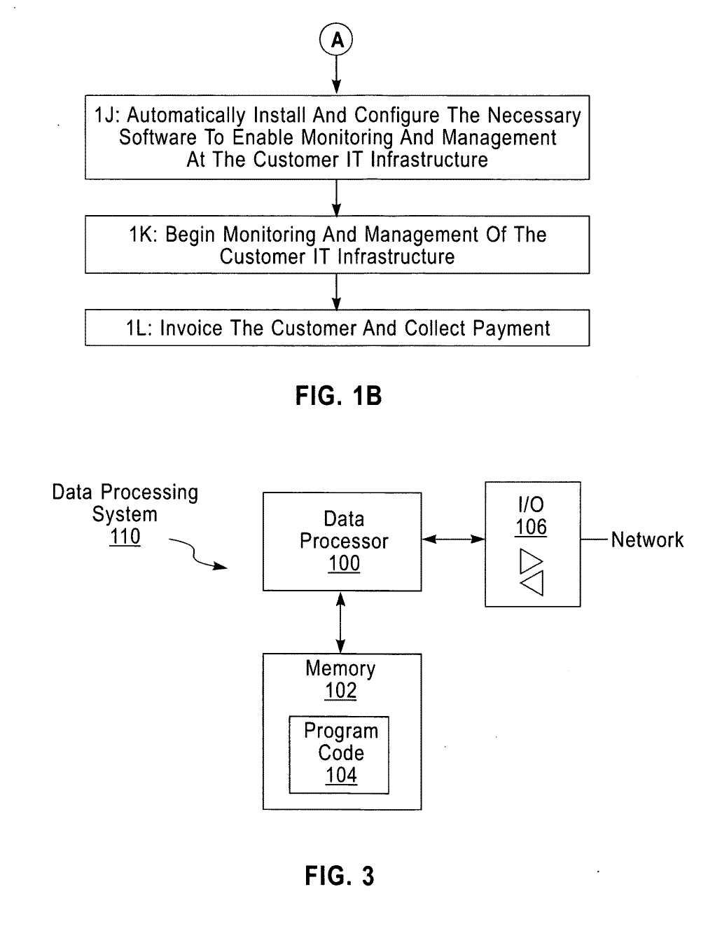

The main steps in the process can be summarized as follows (see also FIGS. 1 and 2):

1A. A potential customer 10 (e.g., a potential SMB customer) shops for RMIS, at a RMIS web site 30 having a RMIS web application 32 that includes a RMIS-specific web application server 36, using a browser on a local machine (e.g., a PC or a workstation).
1B. The RMIS web application 32 downloads a RMIS web client 10A (provisions the local machine with the RMIS web client software) and launches, via the RMIS web client 10A, a network discovery tool to detect, at the customer's site, the customer's IT environment (customer's IT infrastructure 12).
1C. The customer 10 validates on the RMIS web application 32 the resources discovered at step 1B in accordance with the customer's IT environment 12.
1D. The customer 10 selects on the RMIS web application 32 the resources (e.g., systems, applications, network devices, middleware and databases) to be managed from the resources validated at step 1C. In the non-limiting example of FIG. 2 these validated resources may include a web server and OS 14, an application server and OS 16, and a database and OS 18. The customer IT infrastructure 12 can also include a portal 20 that sits behind a FW 22, and that has connectivity to the internet 52. The portal 20 may also be a resource to be monitored.
1E. The RMIS web application 32 prompts the customer 10 to provide any additional credentials required to enable remote monitoring.
1F. A RMIS back-end 34 checks for monitoring pre-requisites for all customer-selected systems, applications, middleware and databases. The RMIS back-end 34 can include, for example, a CMDB 38, asset management system 40, a monitoring system 42, help desk tools 44, 46, and a portal 48 that sits behind a FW 50 having internet connectivity.
1G. The RMIS web application 32 sends inventory and configuration data to the RMIS back-end 34.
1H. The RMIS back-end 34 computes a service price and prompts the customer 10 to “Buy” via the RMIS web application 32.
1I. Upon selection of “Buy” by the customer 10, the RMIS web client 10A initiates any needed FW 22 configuration for site-to-site VPN and NATing of endpoints. This occurs with minimal or no customer intervention. Note that upon the customer 10 selecting to buy or purchase the RMIS service(s), the customer may be considered to become a client of the RMIS 30.
1J. The RMIS web client 10A then automatically installs and configures the necessary software to enable monitoring and management at the customer IT infrastructure 12, with or without intervention by the customer.
1K. The RMIS back-end 34 begins the monitoring and management of the customer IT infrastructure 12. The monitoring and management function can take place via the portals 20 and 48, FWs 22 and 50, and the intervening data communications network (e.g., the interne. 52)
1L. The RMIS back-end 34 sends invoices to the customer 10 and collects payment.

The significant benefits and advantages that can be realized by the use of the foregoing procedures and processes include, but are not limited to, the following:

(i) An accurate assessment of the customer's environment (the customer IT infrastructure 12) is made since its discovery is performed programmatically and subsequently confirmed by the customer, rather than relying solely on an inventory provided to the RMIS 30 by the customer 10.
(ii) A complete collection of configuration data can be made using automatic check-up and systematic lists of requirements on the web.
(iii) There is an acceleration and simplification of the customer experience with the RMIS 30 through the reduction of the configuration overhead required from the customer 10.

Additionally, and although the foregoing focuses mainly on technical issues that are addressed and solved by the use of embodiments of this invention, the process in accordance with the embodiments of this invention also facilitates the setup of a customer single point of contact. This single point of contact accelerates non-technical steps such as obtaining install permissions, provisioning and procurement.

FIG. 2 shows diagrammatically a remote managed services customer on-boarding process based on the embodiments of this invention. Each item and the flow of information between these items during the operational phase are described below. Those skilled in the art will appreciate, however, that the customer's technical environment (the customer IT infrastructure 12) can be replaced with any other IT infrastructure without altering the model of the on-boarding process made possible by the use of the embodiments of this invention.

Item 1 represents the customer 10 who navigates (2) on the RMIS specific web application 32, such as one found at IBM.com, using the browser on the local machine. The customer 10 owns or has responsibility for a technical environment comprised of, typically, multiple network elements, servers, desktops, operating systems, middleware and applications (generally the customer IT infrastructure 12). The diagram of FIG. 2 illustrates one non-limiting customer environment as a web environment with the web server 14, application server 16 and database 18. For example, the customer 10 could be a retailer of goods and/or services over the internet 52 to its own customers (not shown in FIG. 2).

In Task (i) the customer 10 shops (2) via the RMIS specific web application 32 for RMIS monitoring and management services for the customer's environment 12. The RMIS 30 could be physically located anywhere, as could the customer 10.

Once the customer 10 has decided to purchase RMIS services for the customer's environment 12, the RMIS web application 32 prompts for a customer account registration. The RMIS web application 32 downloads and launches via the RMIS web client 10A a network discovery tool to discover the customer's environment. In one non-limiting embodiment of this invention the RMIS web client 10A is embodied as a java applet, and the discovery tool is one similar to or based on NMAP (http://nmap.org).

For example, one feature of NMAP is a ping scan mode. This scan type lists the hosts within a specified range that responded to a ping. The ping scan mode enables the detection of which computers are online, rather than which ports are open. Several methods can be used, including ping sweeping. One method sends an ICMP ECHO REQUEST (ping request) packet to the destination system. If an ICMP ECHO REPLY is received, the system is assumed to be up, and ICMP packets are not blocked. If there is no response to the ICMP ping a “TCP Ping” is attempted to determine whether ICMP is blocked, or if the host is actually not online. A TCP Ping sends either a SYN or an ACK packet to the IP address or hostname on the remote system. If RST, or a SYN/ACK, is returned, then the remote system is online. If the remote system does not respond, either it is offline, or the chosen port is filtered and thus not responding to anything.

The NMAP approach also enables the detection of OS types, applications and services on active ports.

Those skilled in the art will appreciate, however, that any other web technology can be leveraged and used to implement the RMIS web client 10A such as, but not limited to, ActiveX, browser plug-ins, or browser extensions. Similarly, any suitable discovery tool (proprietary or third-party) can be used to determine the resources in a RMIS device baseline list without altering the model of the RMIS on-boarding process in accordance with the exemplary embodiments of this invention.

The discovered customer environment 12, that is automatically/programmatically discovered by any suitable means, is presented to the customer 10 via the RMIS web application 32, allowing the customer 10 to validate the discovered environment and to select those systems to be monitored (which may be the full set of customer IT resources or some sub-set of the customer IT resources).

In Task A, the RMIS web application 32 creates a customer account instance (3) on the CMDB database 38, which represents a file or a collection of files that stores the configuration items for RMIS customers 10, including customer web account data.

In Task B, the RMIS web application 32 automatically discovers and populates the CMDB 38 with the data provided by the customer 10 when the customer elects the elements from the displayed list to be monitored in the environment 12. The customer provides credentials required to this end, such as company information including notification mail and email addresses, phone numbers, etc. The devices on the network are discovered by the web application and can be presented to the customer in a form with checkboxes. The application also checks the prerequisites for all the devices, i.e., those prerequisites required for monitoring. These additional credentials are needed for the RMIS to access the devices for initial configuration and steady-state management. SNAPPiMON is a registered trademark of International Business Machines Corporation, and embodies an enterprise IT monitoring platform that provides agentless monitoring of networks, servers, databases, middleware and applications, and is one exemplary embodiment for implementing the RMIS 30.

Item 4 in FIG. 2 represents the RMIS portal 48. The functionality of the portal 48 is based on interactions with the CMDB database 38, as well as with the management modules 40, 42, 44, 46, depicted generally by the Item 5. These management modules, such as but not limited to the asset management module 40, monitoring module 42 and helpdesk modules 44, 46, represent those modules that the RMIS portal 48 interacts with to provide the requested and contracted RMIS services.

The RMIS back-end 34 computes the service price and prompts the customer to “Buy” via the RMIS web application 32. Any suitable model may be used during the computation of the price for the requested RMIS services.

In Task (ii) the RMIS web application, running on the web application server 36, upon completion of the RMIS services shopping transaction installs via the RMIS web client 10A the necessary software (Item 6 and Item 7) and configures the software with or without customer intervention to allow the functionality of the selected RMIS services.

Item 6 represents the customer-to-RMIS site VPN that carries the secure connection between the RMIS customer/client 10 and the provider of the RMIS. The RMIS web application 36 can either guide the customer through the firewall 22 configuration to setup the VPN and NATing of endpoints, or the setup can be performed automatically and without customer involvement.

Item 7 represents any software necessary to be installed on the customer's systems in order for the RMIS 30 to provide the services that were purchased/contracted for by the customer 10.

At this point the customer 10 is on-board and can be provided with the selected RMIS management services. The RMIS back-end 34 begins monitoring and management of the customer IT infrastructure 12, and also initiates invoicing and the collection of payment.

As will be appreciated by one skilled in the art, aspects of the present invention may be embodied as a system, method and/or computer program product stored on or in a computer-readable storage medium.

The system can be composed of a plurality of computers and related sub-systems, such as is generally shown in FIG. 2 as the RMIS web application 32 and the RMIS back-end 34. In other embodiments all of this functionality may be embodied in a single computer and related sub-systems.

In other embodiments all of the functionality of the RMIS back-end 34 may be embodied in a single computer and related sub-systems. In some embodiments the RMIS web application 32 and the RMIS back-end 34 may be co-located, while in other embodiments the functionality of the web application 32 and the RMIS back-end 34 can be geographically dispersed (e.g., the functionality of the RMIS web application 32 may be located in a country A, while the functionality of all or some of the RMIS back-end 34 may be located in country B.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

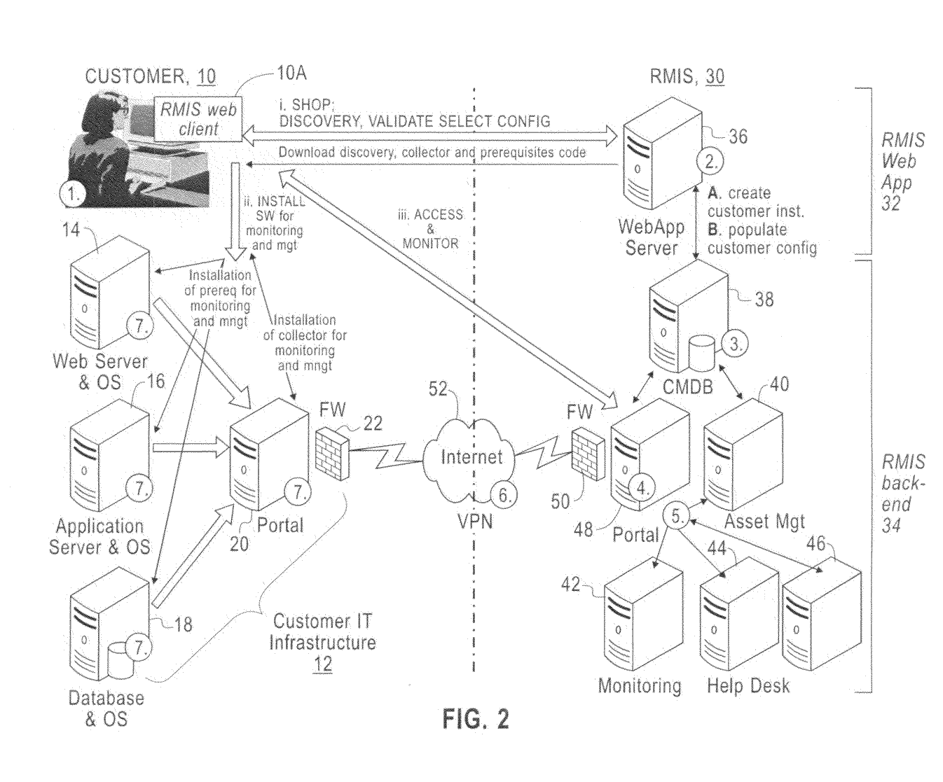

Referring to FIG. 3 there is shown an example of a computer or data processor 100 that is coupled with at least one computer readable medium such as a memory 102 that stores executable program code 104 and other information. Also coupled with the computer or data processor 100 is at least one input/output (I/O) circuit 106 suitable for receiving data from a network and for transmitting data to the network. The components shown in FIG. 3 may be considered to represent a data processing system 110, and to further represent an exemplary embodiment of any one of the various components shown in FIG. 2 (e.g., the web server and OS 14, the database an OS 18, the web application server 36 and the CDMB 38).

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In the example of FIG. 2 the remote computer(s) of the RMIS 30 are have a connection to the computers of the customer 10 via at least the internet 52 and the VPN, via FWs 22 and 50.

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium (such as the memory 102 of FIG. 3) that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

As such, various modifications and adaptations may become apparent to those skilled in the relevant arts in view of the foregoing description, when read in conjunction with the accompanying drawings and the appended claims. As but some examples, the use of other similar or equivalent mathematical expressions may be used by those skilled in the art. However, all such and similar modifications of the teachings of this invention will still fall within the scope of this invention.

What is claimed is:

1. A method to initiate remote managed infrastructure services for a customer infrastructure site, comprising:
in response to an inquiry from a potential customer, provisioning the potential customer with a remote managed infrastructure services software client;
using the provisioned software client, performing an automated process to detect specifics of a customer information technology infrastructure;
in response to the customer confirming the detected specifics of customer information technology infrastructure, configuring a remote managed infrastructure service to monitor and manage all or a subset of the detected and confirmed customer information technology infrastructure.

2. The method of claim 1, where configuring comprises an initial step of computing a cost to monitor and manage all or a subset of the detected and confirmed customer information technology infrastructure, and prompting the customer to purchase the remote managed infrastructure service.

3. The method of claim 2 further comprising, in response to the customer agreeing to purchase the remote managed infrastructure service, installing and configuring software needed at the customer infrastructure site to enable the monitoring and managing of all or the subset of the detected and confirmed customer information technology infrastructure.

4. The method of claim 3, where installing and configuring comprises configuring at least a customer infrastructure site firewall to enable the establishment of a virtual private network and network address translations between the remote managed infrastructure service the customer infrastructure site.

5. The method of claim 3, where installing and configuring operates without customer involvement.

6. A computer-readable storage medium having computer-executable program code stored thereon or therein, execution of the program code resulting in initiating remote managed infrastructure services for a customer infrastructure site, comprising operations of:
in response to an inquiry from a potential customer, provisioning the potential customer with a remote managed infrastructure services software client;
using the provisioned software client, performing an automated process to detect specifics of a customer information technology infrastructure;
in response to the customer confirming the detected specifics of customer information technology infrastructure, configuring a remote managed infrastructure service to monitor and manage all or a subset of the detected and confirmed customer information technology infrastructure.

7. The computer-readable storage medium of claim 6, where configuring comprises an initial operation of computing a cost to monitor and manage all or a subset of the detected and confirmed customer information technology infrastructure, and prompting the customer to purchase the remote managed infrastructure service.

8. The computer-readable storage medium of claim 7 further comprising, in response to the customer agreeing to purchase the remote managed infrastructure service, installing and configuring software needed at the customer infrastructure site to enable the monitoring and managing of all or the subset of the detected and confirmed customer information technology infrastructure.

9. The computer-readable storage medium of claim 8, where installing and configuring comprises an operation of configuring at least a customer infrastructure site firewall to enable the establishment of a virtual private network and network address translations between the remote managed infrastructure service the customer infrastructure site.

10. The computer-readable storage medium of claim 8, where installing and configuring operates without customer involvement.

11. A system comprising at least one computer coupled with at least one memory containing computer-executable program code stored thereon or therein, the at least one computer being coupled with a data communications network and the execution of the program code resulting in the system providing remote managed infrastructure services for a customer infrastructure site, comprising:
in response to an inquiry from a potential customer, provisioning the potential customer with a remote managed infrastructure services software client;
using the provisioned software client, performing an automated process to detect specifics of a customer information technology infrastructure;
in response to the customer confirming the detected specifics of customer information technology infrastructure, configuring a remote managed infrastructure service to monitor and manage all or a subset of the detected and confirmed customer information technology infrastructure.

12. The system of claim 11, where configuring comprises an initial operation of computing a cost to monitor and manage all or a subset of the detected and confirmed customer information technology infrastructure, and prompting the customer to purchase the remote managed infrastructure service.

13. The system of claim 12 further comprising, in response to the customer agreeing to purchase the remote managed infrastructure service, operations of installing and configuring software needed at the customer infrastructure site to enable the monitoring and managing of all or the subset of the detected and confirmed customer information technology infrastructure.

14. The system of claim 13, where the operations of installing and configuring comprise an operation of configuring at least a customer infrastructure site firewall to enable the establishment of a virtual private network and network address translations between the remote managed infrastructure service the customer infrastructure site.

15. The system of claim 13, where the operations of installing and configuring operate without customer involvement.
